(19) United States
(12) Patent Application Publication
(10) Pub. No.: US 2009/0040887 A1
(43) Pub. Date: Feb. 12, 2009

(54) OPTICAL DISK REPRODUCTION APPARATUS

(75) Inventor: Yasuhiro Hayashi, Yokohama-Shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/186,841

(22) Filed: Aug. 6, 2008

(30) Foreign Application Priority Data
Aug. 8, 2007 (JP) 2007-206142

(51) Int. Cl. G11B 7/00

(52) U.S. Cl. 369/44.11; G9B/7

(57) ABSTRACT

This disclosure concerns an optical-disk reproduction apparatus comprising an amplifier which supplies information from an optical-disk as an information signal and a servo error signal; a servo controller controlling an optical-pickup read operation in response to the servo error signal; a rotation address producer producing a rotation address corresponding to a rotation angle of the optical disk; a memory in which the information signal, the servo error signal, and the rotation address are received and stored while correlated with one another; an error flag producer producing an error flag when determining that an error exists in the information signal; and a system controller determining a factor of production of the error flag using the servo error signal and rotation address stored in the memory, when the error flag producer produces the error flag, the system controller adjusting a servo parameter in the servo control circuit according to the determination result.

### CROSS-REFERENCE TO RELATED APPLICATION

This application is based upon and claims the benefit of priority from the prior Japanese Patent Applications No. 2007-206142, filed on Aug. 8, 2007, the entire contents of which are incorporated herein by reference.

### BACKGROUND OF THE INVENTION

1. Field of the Invention

The present invention relates to an optical disk reproduction apparatus.

2. Related Art

In an optical disk reproduction apparatus, when error check code for reading data to indicate data reliability indicates an error, a retry process of reading data again is performed by doing a seek again right to an area where error data exists.

In the case where incorrect read of data is caused by a physical factor such as dirt adhering to an optical disk and a defect or an accidental factor such as vibration, frequently a read error is generated again when a retry process is simply performed on the same condition as the previous time without changing a parameter of a servo system circuit.

There have been various techniques of improving the read error. For example, in a technique disclosed in JP-A 2001-202636(KOKAI), a servo parameter is changed according to the number of retries.

There is also proposed a technique of giving a priority to a parameter having a high error frequency to change the parameter of a retry process based on error factor information in the retry process.

There is also proposed a technique in which result of successful read retry is retained and reflected to enhance the read accuracy in the retry process.

However, in any conventional technique, the retry is repeated by trial and error without analyzing the error factor, and only the read accuracy is enhanced based on the number of retries, the error frequency, and conditions of the successful retry. Therefore, the error factor cannot be directly analyzed to enhance the read accuracy in the retry process. Accordingly, the number of retries is unnecessarily increased to lengthen a data read time, which leads to deterioration of drive performance.

### SUMMARY OF THE INVENTION

An optical disk reproduction apparatus according to an embodiment of the present invention comprises an amplifier which supplies information from an optical disk as an information signal and a servo error signal; a servo controller which controls an optical pickup read operation in response to the servo error signal; a rotation address producer which produces a rotation address corresponding to a rotation angle of the optical disk; a memory in which the information signal, the servo error signal, and the rotation address are received and stored while correlated with one another; an error flag producer which produces an error flag when determining that an error exists in the information signal; and a system controller which determines a factor of production of the error flag using the servo error signal and rotation address stored in the memory, when the error flag producer produces the error flag, the system controller adjusting a servo parameter in the servo control circuit according to the determination result.

### BRIEF DESCRIPTION OF THE DRAWINGS

FIG. 1 is a block diagram showing a configuration of an optical disk reproduction apparatus according to an embodiment of the present invention;

FIG. 2 shows a waveform of the FG address, the tracking error signal TE, the information signal RF, the error flag, and the logical address indicating the position on the optical disk 11;

FIG. 3 is a circuit diagram showing a configuration of a focus-servo control circuit 19 or tracking servo control circuit 16 in the optical disk reproduction apparatus;

FIG. 4 shows an equalizer gain characteristic in the optical disk reproduction apparatus;

FIG. 5 shows an open-loop characteristic curve in the optical disk reproduction apparatus;

FIG. 6 is a flowchart showing a sequence of the read process of the embodiment;

FIG. 7 is a flowchart showing a sequence of the retry process;

FIG. 8 shows that the servo error signal and the information signal are stored in a data buffer RAM while correlated with the FG address; and

FIG. 9 shows a relationship of the address of the servo error signal, the address of the information signal, and the error flag of the information signal in the optical disk reproduction apparatus.

### DETAILED DESCRIPTION OF THE INVENTION

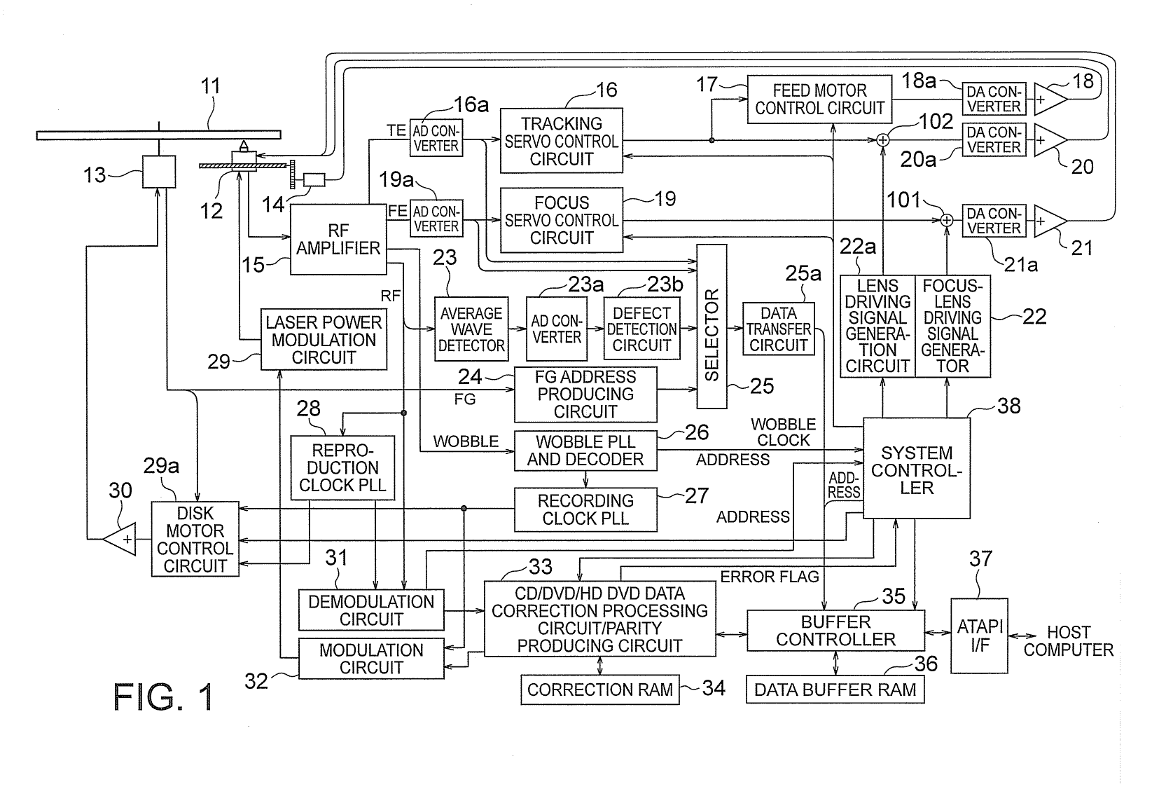

An optical disk reproduction apparatus according to an embodiment of the invention will be described below with reference to FIG. 1.

An optical pickup 12 reads information from an optical disk 11, and the information is fed into an RF amplifier 15, and the RF amplifier 15 supplies a servo error signal and an information signal RF.

In the servo error signal, after a focus-servo error signal FE for focusing the laser beam on the optical disk 11 is supplied from the RF amplifier 15, an analog-digital (hereinafter abbreviated to AD) converter 19a converts the focus-servo error signal FE into digital data, the digital data is fed into a focus-servo control circuit 19.

An adder 101 adds data supplied from the focus-servo control circuit 19 and data which is necessary to start up focus-servo and produced by a focus-lens driving signal generator 22, and the added data is delivered to a digital-analog (hereinafter abbreviated to DA) converter 21a and converted into an analog signal. The analog signal is imparted to a focus actuator driver 21, and a driving signal is supplied to drive a focus actuator of the optical pickup 12.

In the servo error signal, similarly to the focus-servo error signal FE, a tracking error signal TE for performing control in a track direction on the optical disk 11 is supplied from the RF amplifier 15 and imparted to an AD converter 16a, and the tracking error signal TE is fed into a tracking servo control circuit 16. An adder 102 adds data supplied from the tracking servo control circuit 16 and output data which is supplied from a lens driving signal generator 22a to make a jump during an address seek in the track direction, and the added data is delivered to a DA converter 20a and converted into an analog signal. The analog signal is imparted to a tracking actuator driver 20, and a driving signal is produced to drive a tracking actuator of the optical pickup 12.

The output data from the tracking servo control circuit 16 is also delivered to a feed motor control circuit 17. The feed motor control circuit 17 amplifies and supplies a low component necessary to move the optical pickup 12 in a radial direction of the optical disk 11. The signal supplied from the feed motor control circuit 17 is imparted to a DA converter 18a and converted into an analog signal, and the analog signal is imparted to a feed motor driver 18. The feed motor driver 18 produces a driving signal to drive a feed motor 14. A system controller 38 controls the servo system.

The information signal RF is imparted to a reproduction clock PLL (Phase-Locked Loop) 28 to extract a bit clock. The extracted clock and the information signal RF are imparted to a demodulation circuit 31 to perform separation of a synchronous signal and demodulation, and the data is delivered to a CD/DVD/HD DVD data correction processing circuit/parity producing circuit (hereinafter, correction processor/parity producer) 33. The correction processor/parity producer 33 performs a correction process using a correction RAM 34.

The data to which the correction process is performed is tentatively stored in a data buffer RAM 36 on the basis of control of a buffer controller 35, and the data is transmitted to a host computer (not shown) through an ATAPI interface (hereinafter abbreviated to I/F) 37.

The correction processor/parity producer 33 is operated as an error flag producer in addition to the performance of the correction process. The correction processor/parity producer 33 determines a correction state of read data. When the correction processor/parity producer 33 determines that error exists, the correction processor/parity producer 33 produces an error flag and delivers the error flag to the system controller 38, and the system controller 38 determines quality of each read data.

A disk motor control circuit 29a produces a control signal on the basis of the bit clock extracted by the reproduction clock PLL 28, and a driver 30 drives a disk motor 13 to rotate the optical disk 11.

During the recording, the data is transmitted from the host computer (not shown), and the data is tentatively stored in the data buffer RAM 36 through the buffer controller 35. The data is delivered to the correction processor/parity producer 33, parity data is added to the data, and the data is delivered to the modulation circuit 32.

The modulation circuit 32 modulates the data to produce a stream signal, and the stream signal is imparted to the laser power modulation circuit 29. The laser power modulation circuit 29 converts the stream signal into a pulse signal, and the optical pickup 12 records a pattern on the optical disk 11.

During the recording, the disk rotation is controlled based on a wobble clock. The wobble clock is produced by imparting the wobble signal, produced by the RF amplifier 15, to a wobble PLL and decoder 26.

The wobble PLL and decoder 26 also decodes address information on the optical disk 11, which is modulated and written in the imparted wobble signal, and the wobble PLL and decoder 26 produces address information for enabling determination of a recording position. Then, the wobble PLL and decoder 26 supplies the address information to the system controller 38.

The wobble clock supplied from the wobble PLL and decoder 26 is also imparted to a recording clock PLL 27 to produce a recording modulation clock, and the recording modulation clock is imparted to the modulation circuit 32.

The operation of each circuit is controlled by a command provided from the system controller 38.

The information signal RF supplied from the RF amplifier 15 is also imparted to an average wave detector 23, the detection of the information signal RF is performed by an average, and an AD converter 23a converts the signal supplied from the average wave detector 23 into digital data.

The digital data is imparted to a defect detection circuit 23b, the defect detection circuit 23b compares the digital data to a predetermined value to detect a defect existing in the optical disk 11, and the defect detection circuit 23b supplies a determination flag to a selector 25. The selector 25 selectively supplies the determination flag to a data transfer circuit 25a.

On the other hand, the optical disk 11 is rotated, the disk motor 13 which is operated as a rotation address producer supplies an FG signal to an FG address producing circuit 24 to produce FG address data, and the FG address producing circuit 24 feeds the FG address data into the selector 25. The FG signal indicates a rotation address according to a rotation angle, and the FG address data indicates the rotation angle. The FG address data is positional information on the optical disk 11, and the FG address data may be an absolute angle or relative accuracy based on an arbitrary angle.

The FG address data is also delivered to the data transfer circuit 25a through the selector circuit 25 and the FG address data is sequentially delivered to the buffer controller 35 and stored in the data buffer RAM 36.

The pieces of digital data of the tracking error signal TE and focus error signal FE supplied from the AD converters 16a and 19a are also imparted to the data transfer circuit 25a through the selector 25, and the pieces of digital data are delivered to the buffer controller 35 and stored in the data buffer RAM 36. In the data buffer RAM 36, in order to store the tracking error signal TE and focus error signal FE which are of the servo error signal, a ring buffer is provided in an area that is different from the original area in which the read or write data is stored. The two to three-rotation data is stored in the ring buffer.

The system controller 38 can directly access the ring buffer area to monitor states of the past tracking error signal TE and focus error signal FE again.

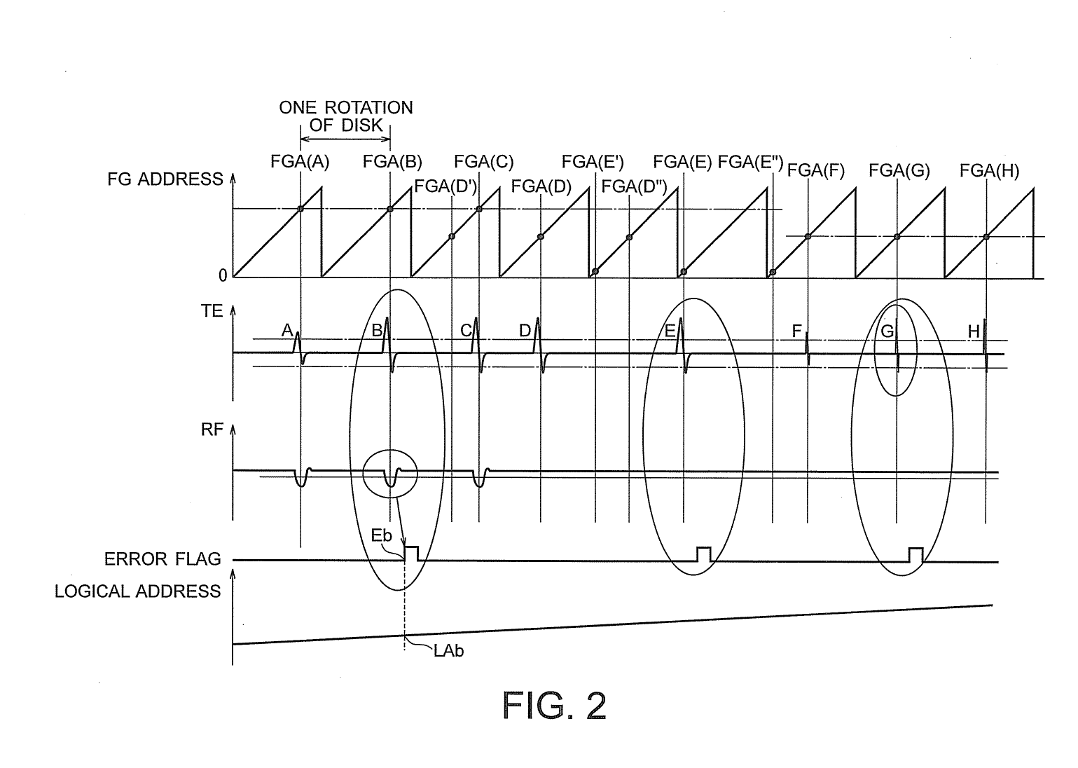

FIG. 2 shows a waveform of the FG address, the tracking error signal TE, the information signal RF, the error flag, and the logical address indicating the position on the optical disk 11. The system controller 38 can access the FG address, the tracking error signal TE, the information signal RF, the error flag, and the logical address.

The FG address produced by the FG address producing circuit 24 is formed by a sawtooth waveform, and the FG address indicates the positional information in which a period is one rotation of the disk. The tracking error signal TE and the information signal RF are recorded while synchronized with the rotation angle of the optical disk 11 corresponding to the FG address.

In FIG. 2, the tracking error signal TE is shown as the servo error signal although the focus error signal FE is not shown. Because the tracking error signal TE and the focus error signal FE exhibits a similar change in waveform concerning the error generation factor determination, both or one of the tracking error signal TE and the focus error signal FE may be used.

The error flag information and the logical address information on the optical disk 11 are also transferred to the buffer controller 35 and stored in the data buffer RAM 36. At this point, in the logical address information, it is not always necessary that all the pieces of positional information on the optical disk 11 is recorded, but a position where an error is generated and the like may be used as long as the logical address information has resolution of a degree in which a relationship between the FG address and each servo error signal is seen.

Thus, the FG address, the servo error signal, the information signal RF, the error flag, and the logical address, which indicate the physical positional information on the optical disk 11, are recorded in the data buffer RAM 36 while linked with one another in time series.

When the error flag is supplied from the correction processor/parity producer 33, it is tentatively stored in the data buffer RAM 36. The system controller 38 accesses the data buffer RAM 36 to monitor the presence or absence of the error flag. When the error flag is generated, the system controller 38 reads the tracking error signal TE, the information signal RF, the FG address, and the logical address which correspond to the position at which the error flag is recorded. When the error is generated in the logical address, the logical address can normally be obtained from around the logical address.

Usually, in the error flag, a temporal delay is generated from the error generation because the presence or absence of the error is determined and generated after various processes such as the correction process and the error flag process are performed. Therefore, frequently the information during the production of the error flag is not temporarily matched with the information during the error generation. On the other hand, because the logical address is frequently used during the seeking, and the correction process is not required, and the temporal delay becomes small.

Accordingly, the logical address of the data in which the error is generated is checked against the tracking error signal TE or FG address which is recorded in the data buffer RAM 36, which allows the servo error signal to be searched at the position where the error is generated.

Then, the FG address during the generation of the error is stored in the data buffer RAM 36, and the tracking error signal TE and information signal RF of the same FG address before and after one rotation are searched. When the similar disturbances (rampages) exist in the tracking error signal TE and information signal RF, it can be determined that the error is caused by the defect of the optical disk 11 depending on the rotation. The disturbance (rampage) indicate that the signal RF and/or TE deviates from a predetermined range.

The disturbances (rampages) A, B, C, . . . of the tracking error signal TE and information signal RF indicate the defect on the optical disk 11. When an error flag Eb is generated by the factor of the defect, a logical address LAb is stored in the data buffer RAM 36. It is checked whether or not the disturbances (rampages) exist in the tracking error signal TE and information signal RF for the information existing in front of the logical address LAb. The disturbance (rampage) of the signal can easily be detected based on whether or not the signal exceeds a predetermined level.

An FG address FGA(B) is read in generating the disturbance (rampage) of the signal, the tracking error signal TE and the information signal RF are read in an FG address FGA(A) and an FG address FGA(C) at the same positions before and after the one rotation, and changes in levels are observed.

When the disturbances (rampage) of the signals are detected like the tracking error signal TE and information signal RF in the FG addresses FGA(A), FGA(B), and FGA(C), it can be determined that the defect exists in the optical disk 11. In such cases, a resistance characteristic of the servo for the defect of the optical disk 11 can be improved such by performing the control so as to lower a gain of the tracking servo control circuit 16, focus-servo control circuit 19, or pickup 12 as the parameter of the servo system circuit. The retry process is performed after the gain is lowered, which allows the improvement of the data read accuracy.

On the other hand, like the FG addresses FGA(D) and FGA(E), when the disturbance (rampage) is observed only in the tracking error signal TE while the disturbance (rampage) is not generated in the information signal RF, frequently the error is generated in the data read by the accidental factor such as the vibration which is independent of the rotation. In such cases, similarly the disturbances (rampages) are not observed for the tracking error signal TE and information signal RF in the FG addresses FGA(D′), FGA(D″), FGA(E′), and FGA(E″) at the same positions before and after one rotation.

In this case, the read accuracy can be improved by performing the retry process with the same gain, or the retry process is performed while the setting parameter is changed to increase the gain, which allows the improvement of the read accuracy.

In the case of the FG addresses FGA(A), FGA(B), and FGA(C), the disturbances (rampage) are observed in both the levels of the tracking error signal TE and information signal RF. However, for a thin scratch on the optical disk 11, because of the short time during which the level is changed by the influence of the scratch, frequently a level fluctuation is not observed in the information signal RF. In such cases, only the change in level is observed in the tracking error signal TE.

In the FG address FGA(G), although the disturbance (rampage) is generated in the tracking error signal TE, the level of the information signal RF is hardly changed. The same holds true for the FG addresses FGA(F) and FGA(H) before one rotation. That is, when the light with which the optical disk 11 is illuminated is reflected and accepted, the disturbance (rampage) is generated in the tracking error signal TE although the disturbance (rampage) is hardly generated in the information signal RF. In such cases, it can be determined that the disturbance (rampage) is caused by the thin scratch on the surface of the optical disk 11. Therefore, the retry process is performed after the gain is lowered, which allows the improvement of the read accuracy.

In determining the read error factor by the above sequence, when a jump is suddenly made to a position which is far from the read position due to the defect, it is possibly considered that the disturbance (rampage) of the signal level cannot be detected before or after one rotation as long as the data of one more rotation is taken in.

However, the above-described phenomenon is hardly generated in the usual defect in the optical disk 11. In almost all cases, because the beam spot has an extremely small diameter, the light enters an inside region of the defect little by little, and the level fluctuation caused by the defect emerges gradually in the servo error signal or information signal RF.

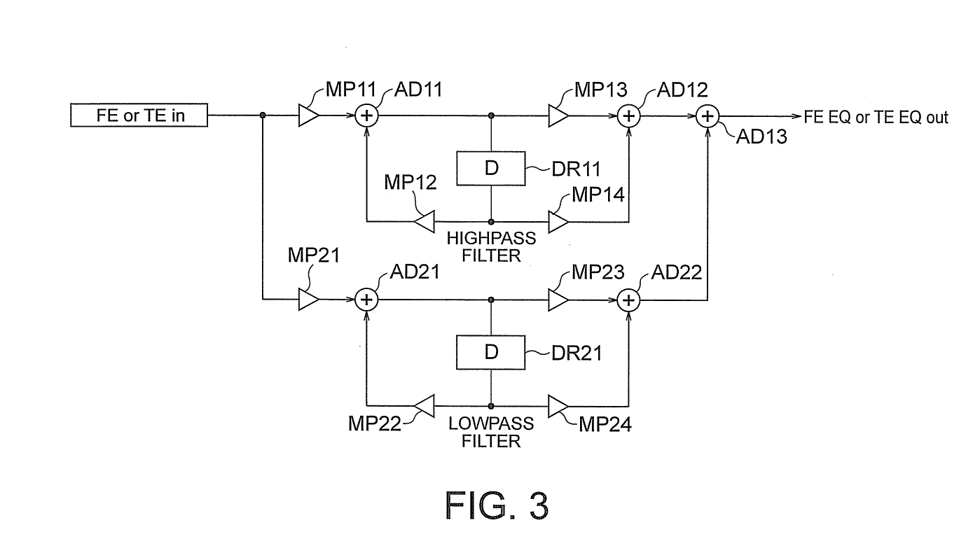

FIG. 3 shows contents of a computation process performed by the focus-servo control circuit 19 or tracking servo control circuit 16, which is composed of the digital circuit.

The focus error signal FE or the tracking error signal TE is fed and supplied through a highpass filter, or the focus error signal FE or the tracking error signal TE is fed and supplied through a lowpass filter.

In the highpass filter, an adder AD11 adds a value obtained by multiplying the focus error signal FE or tracking error signal TE by a multiplication coefficient MP11 and a value obtained by multiplying the output of the adder AD11 by a multiplication coefficient MP12 after delaying the output of the adder AD11 at a sample delay register DR11. The data supplied from the adder AD11 is delayed by the sample delay register DR11 and multiplied by a multiplication coefficient MP14, and the data supplied from the adder AD11 is also multiplied by a multiplication coefficient MP13. An adder AD12 adds both the pieces of data, and the adder AD12 adds supplies data to an adder AD13.

Similarly, in the lowpass filter, an adder AD 21 adds the focus error signal FE or tracking error signal TE which is multiplied by a multiplication coefficient MP21 and a value which is multiplied by a multiplication coefficient MP22 after a delay is performed by a sample delay register DR21, and the adder AD21 supplies data. The data supplied from the adder AD21 is delayed by the sample delay register DR21 and multiplied by a multiplication coefficient MP24, and the data supplied from the adder AD21 is also multiplied by a multiplication coefficient MP23. An adder AD22 adds both the pieces of data, and the adder AD22 adds supplies data to the adder AD13. The adder AD13 adds the value supplied through the highpass filter and the value supplied through the lowpass filter, and the adder AD13 finally supplies a focus error equalizing signal FEEQ or a tracking error equalizing signal TEEQ.

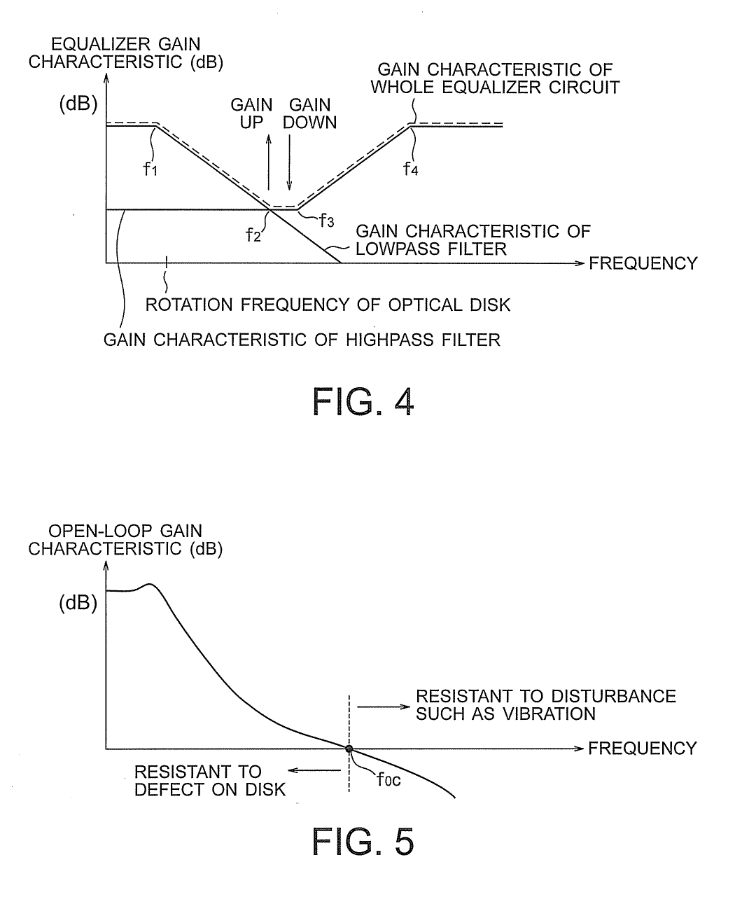

FIG. 4 shows an equalizer gain characteristic obtained by the focus-servo control circuit 19 or tracking servo control circuit 16.

The gain characteristic of the lowpass filter is lowered as a frequency becomes higher than f1. On the contrary, the gain characteristic of the highpass filter is increased as the frequency becomes higher than f3 (f3>f1), and the gain characteristic is kept constant after the frequency reaches f4. When the gain characteristics of the lowpass filter and highpass filter are added to each other, as shown by a dotted line in FIG. 4, the added gain characteristic is kept constant in the frequency of 0 to f1, the added gain characteristic is lowered to the frequency of F2, the added gain characteristic is maintained at a low level to the frequency of f3, and the added gain characteristic is kept constant after increased in the frequency of f3 to f4.

Desirably the setting is performed such that the gain obtained near the rotation frequency of the optical disk 11 is increased. The characteristic of the focus-servo equalizer circuit 19 or tracking servo equalizer circuit 16 can be changed by setting the whole gain in the above-described manner.

FIG. 5 shows a tracking servo characteristic in the pickup 12. In the open-loop characteristic curve of FIG. 5, a zero-cross frequency f0c which is of the frequency when the gain crosses 0 dB corresponds to a response frequency of the tracking servo.

The zero-cross frequency f0c is increased when the equalizer gain of the whole equalizer circuit shown in FIG. 4 is increased. On the contrary, the zero-cross frequency f0c is decreased when the equalizer gain of the whole equalizer circuit is lowered.

The resistance characteristic against the accidental disturbance such as the vibration is improved without depending on the rotation period by setting the zero-cross frequency f0c at a higher level. When the zero-cross frequency f0c is set at a lower level, the characteristic which is hardly influenced by the defect on the optical disk 11 is obtained depending on the rotation period, which allows the improvement of the resistance characteristic against the defect.

Because the two demands are contradictory to each other, usually the one of the resistance characteristics is selected to optimize the parameter, which allows the improvement of the read accuracy during the retry process.

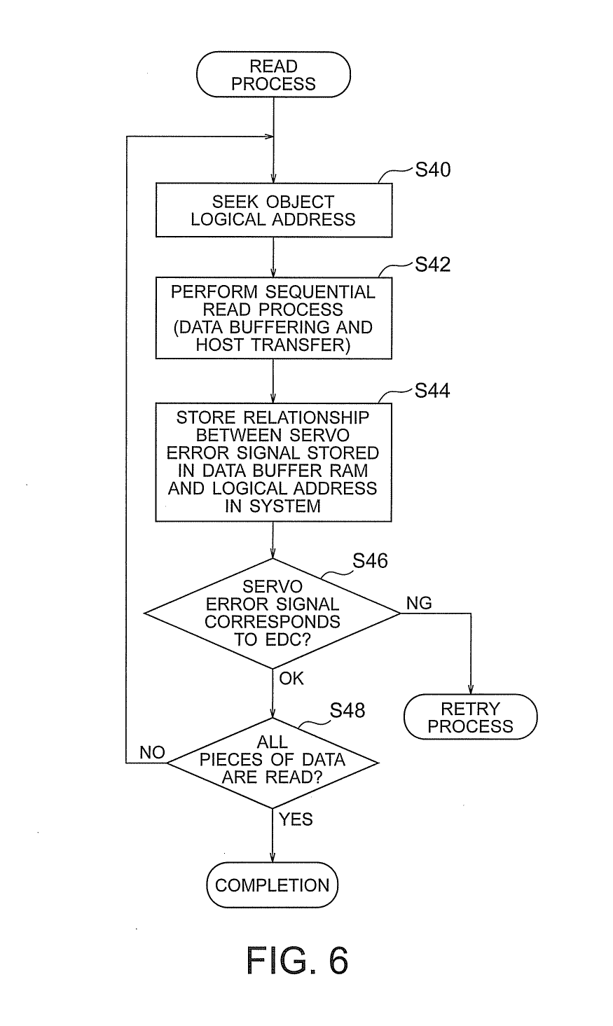

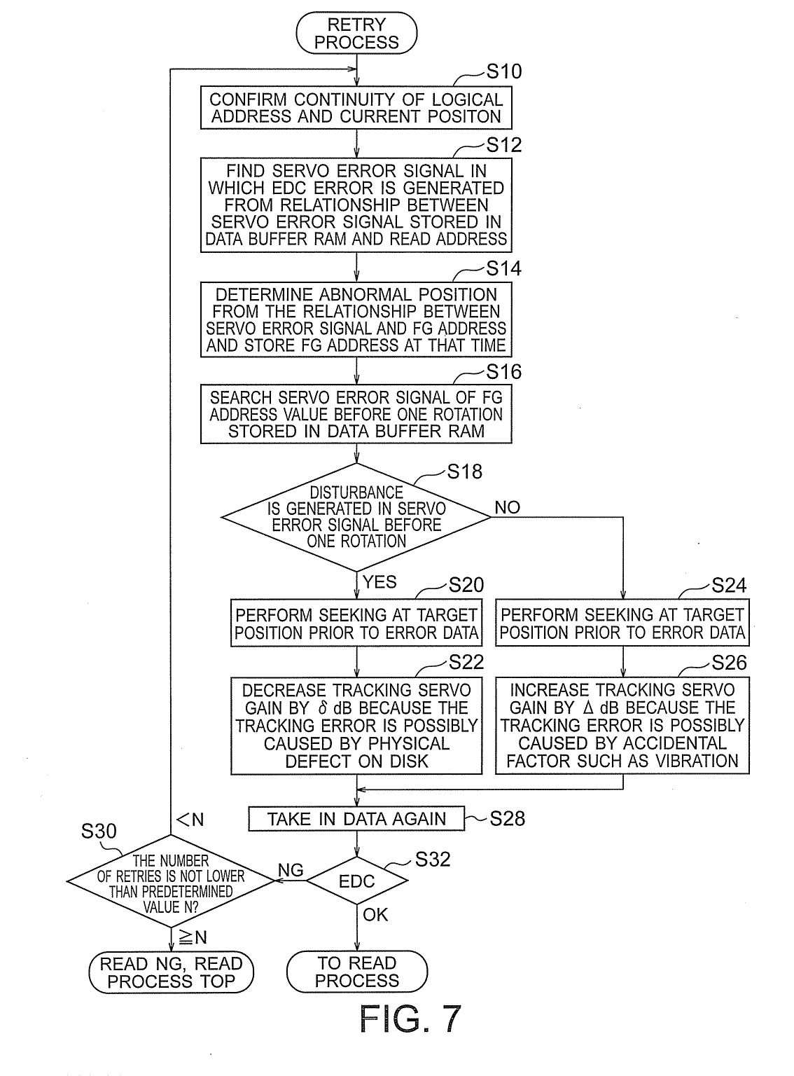

FIG. 6 is a flowchart showing a sequence of the read process of the embodiment, and FIG. 7 is a flowchart showing a sequence of the retry process. The following process is performed by the system controller 38.

In Step S40, a target logical address is sought.

In Step S42, the sequential read process is performed, and the data read from the optical disk 11 is supplied to the host computer while stored in the data buffer RAM 36.

In Step S44, during the sequential read process, the FG address and the servo error signal are recorded in the data buffer RAM 36, and the information indicating the relationship between the address and servo error signal and the logical address on the optical disk 11 is simultaneously recorded.

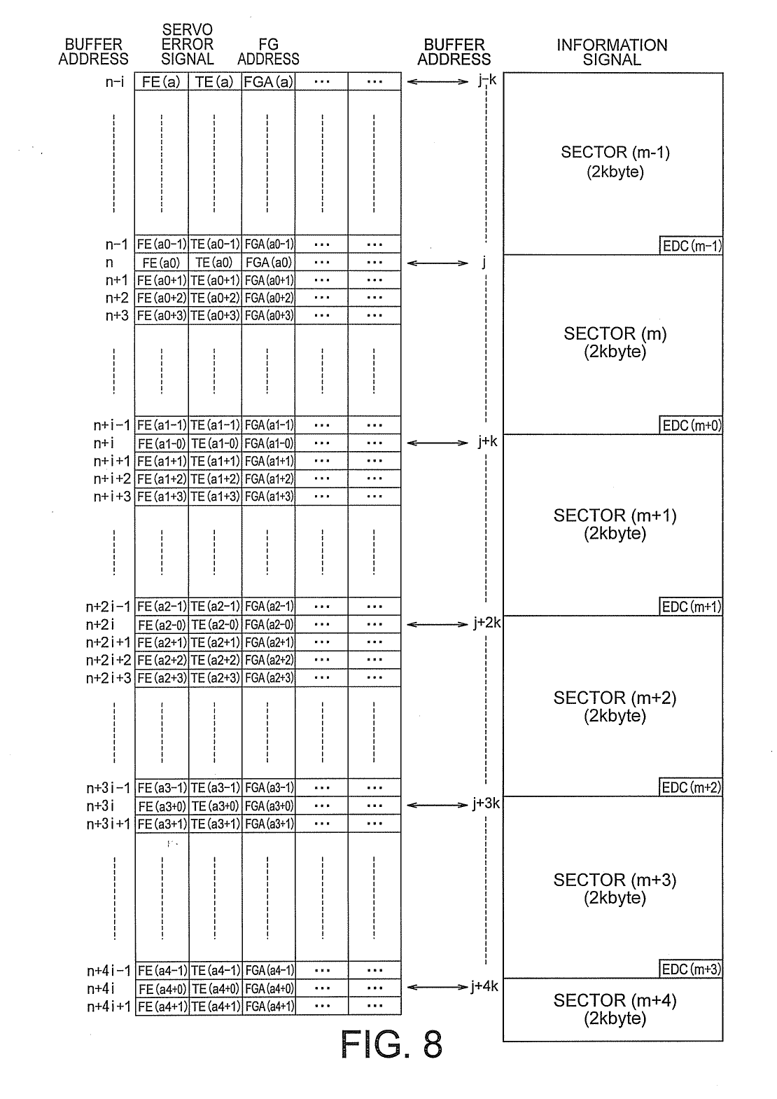

As shown in FIG. 8, the focus error signal FE, the tracking error signal TE, and FG address which are of the servo error signal are stored in the form of the focus error signal FE(a), tracking error signal TE(a), and FG address (a) in the ring buffer of the data buffer RAM 36 while correlated with the address.

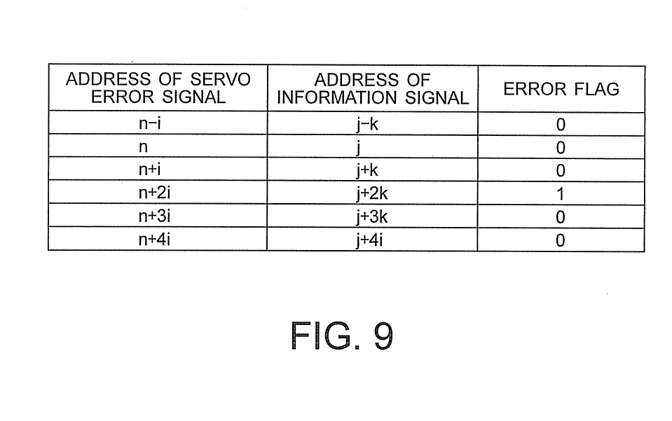

On the other hand, the information signal RF is stored in sector unit in the data buffer RAM 36. As shown in FIG. 9, addresses (=n−i, n, n+i, n+2i, n+3i, and n+4i) in the focus error signal FE(a), tracking error signal TE(a), and FG address (a) is correlated with addresses (=j−k, j, j+k, j+2k, j+3k, and j+4k) of the information signal. In each information signal, the presence or absence (“1” or “0”) of the error flag is stored in sector unit in the data buffer RAM 36.

Thus, the servo error signal is stored while correlated with the FG address, which allows the servo error signal to be easily searched at the position where the data read error occurs.

In Step S46, the system controller 38 determines whether or not the servo error signal corresponds to an Error Detection Code (EDC). When the servo error signal corresponds to EDC, the error flag is produced to perform the retry process which will be described later. In Step S48, the system controller 38 determines whether or not all the pieces of data are read. The process is repeated until all the pieces of data are read.

FIG. 7 is a flowchart showing the sequence of the retry process.

In Step S10, continuity of the logical address and the current position on the optical disk 11 are confirmed when the data read error is generated.

In Step S12, the abnormal servo error signal in which the read error is generated is detected based on the relationship between the servo error signal stored in the data buffer RAM 36 and the read address.

In Step S14, the position at which the read error is generated is determined from the relationship between the detected servo error signal and the FG address, and the FG address at that time is stored in the data buffer RAM 36.

In Step S16, the servo error signal is stored in the FG address before one rotation, which is stored in the data buffer RAM 36.

In Step S18, the system controller 38 determines whether or not the disturbance (rampage) is generated in the servo error signal before one rotation. When the disturbance (rampage) is generated in the servo error signal, the flow goes to Step S20. When the disturbance (rampage) is not generated in the servo error signal, the flow goes to Step S24, and the seeking is performed at the position prior to the position where the read error is generated.

When the disturbance (rampage) is generated in the servo error signal, in Step S22 the system controller 38 determines that the read error is possibly caused by the defect in the optical disk 11, and the tracking servo gain is lowered by a predetermined value δ (dB).

On the other hand, when the disturbance (rampage) is not generated in the servo error signal, in Step S26 the system controller 38 determines that the read error is possibly caused by the accidental factor such as the vibration, and the tracking servo gain is increased by the predetermined value δ (dB) or the retry process is performed with the same gain while the tracking servo gain is not changed.

After the process in Step S22 or S26, the flow goes to Step S28 to perform the retry process of reading the data again.

In Step S32, the system controller 38 determines whether or not the error is generated by comparison with the EDC code. When the error is not generated, the flow returns to Step S40. When the error is generated, the flow goes to Step S30, the processes from Step S10 to Step S30 is repeated predetermined times until the retry process is successful. When the read error is not solved yet even if the number of times reaches the predetermined value, the read process is stopped.

According to the embodiment, when the data read error is generated, the data read accuracy can largely be improved during the retry process by making the determination whether the data read error is caused by the defect depending on the rotation of the optical disk or by the accidental vibration independently of the rotation. As a result, such the optical disk reproduction performance as the speed enhancement of the retry process during the generation of the read error and the improvement of the drive read performance can largely be improved.

The embodiment is described only by way of example, and the invention is not limited to the embodiment. Various modifications can be made without departing from the scope of the invention. For example, although the tracking servo gain setting is described in the embodiment, the similar setting may be performed to the focus-servo gain. Alternatively, as described in the tracking servo gain, the data read system may be set at the optimized parameter according to the optical disk defect depending on the rotation or the accidental vibration independently of the rotation, which allows the data read accuracy to be improved during the retry process.

What is claimed is:

1. An optical disk reproduction apparatus comprising:
an amplifier which supplies information from an optical disk as an information signal and a servo error signal;
a servo controller which controls an optical pickup read operation in response to the servo error signal;
a rotation address producer which produces a rotation address corresponding to a rotation angle of the optical disk;
a memory in which the information signal, the servo error signal, and the rotation address are received and stored while correlated with one another;
an error flag producer which produces an error flag when determining that an error exists in the information signal; and
a system controller which determines a factor of production of the error flag using the servo error signal and rotation address stored in the memory, when the error flag producer produces the error flag, the system controller adjusting a servo parameter in the servo control circuit according to the determination result.

2. The optical disk reproduction apparatus according to claim 1, wherein the servo controller includes a tracking servo controller which controls tracking of the optical pickup, and
the servo parameter is a gain of the tracking servo control circuit.

3. The optical disk reproduction apparatus according to claim 1, wherein the servo controller includes a focus servo controller which controls focusing to the optical disk, and
the servo parameter is a gain of the tracking servo controller.

4. The optical disk reproduction apparatus according to claim 1, wherein the system controller determines whether or not the factor of the production of the error flag is synchronized with rotation of the optical disk using information, the information including the servo error signal in the rotation address in producing the error flag and the servo error signal before one rotation with respect to the rotation address, the both servo error signals being stored in the memory.

5. The optical disk reproduction apparatus according to claim 2, wherein the system controller determines whether or not the factor of the production of the error flag is synchronized with rotation of the optical disk using information, the information including the servo error signal in the rotation address in producing the error flag and the servo error signal before one rotation with respect to the rotation address, the both servo error signals being stored in the memory.

6. The optical disk reproduction apparatus according to claim 3, wherein the system controller determines whether or not the factor of the production of the error flag is synchronized with rotation of the optical disk using information, the information including the servo error signal in the rotation address in producing the error flag and the servo error signal before one rotation with respect to the rotation address, the both servo error signals being stored in the memory.

7. The optical disk reproduction apparatus according to claim 5, wherein the system controller lowers a gain of the tracking servo controller when determining that the factor of the production of the error flag is synchronized with the rotation of the optical disk, and
the system controller increases a gain of the tracking servo controller when determining that the factor of the production of the error flag is not synchronized with the rotation of the optical disk.

8. The optical disk reproduction apparatus according to claim 6, wherein the system controller lowers a gain of the tracking servo controller when determining that the factor of the production of the error flag is synchronized with the rotation of the optical disk, and
the system controller increases a gain of the tracking servo controller when determining that the factor of the production of the error flag is not synchronized with the rotation of the optical disk.

9. The optical disk reproduction apparatus according to claim 5, wherein the system controller lowers a gain of the tracking servo controller when the servo error signal in the rotation address in producing the error flag and the servo error signal before one rotation with respect to the rotation address deviate from a predetermined range.

10. The optical disk reproduction apparatus according to claim 6, wherein the system controller lowers a gain of the tracking servo controller when the servo error signal in the rotation address in producing the error flag and the servo error signal before one rotation with respect to the rotation address deviate from a predetermined range.

11. The optical disk reproduction apparatus according to claim 5, wherein the system controller lowers a gain of the tracking servo control circuit when determining that disturbance exists in each level of the servo error signal and information signal in a first rotation address, and
the system controller increases a gain of the tracking servo control circuit when determining that disturbance does not exist in each level of the information signal in a second rotation address while disturbance exists in the servo error signal in the second rotation address.

12. The optical disk reproduction apparatus according to claim 6, wherein the system controller lowers a gain of the focus servo control circuit when determining that disturbance exists in each level of the servo error signal and information signal in a first rotation address, and
the system controller increases a gain of the focus servo control circuit when determining that disturbance does not exist in each level of the information signal in a second rotation address while disturbance exists in the servo error signal in the second rotation address.
